(19) United States
(12) Patent Application Publication
(10) Pub. No.: US 2026/0369088 A1
(43) Pub. Date: Nov. 19, 2026

(54) A METHOD FOR AUTOMATED MICROSCOPIC SCANNING

(71) Applicant: Roche Diagnostics Operations, Inc., Indianapolis, IN (US)

(72) Inventor: Wenzel Salzmann, Rotkreuz ZG (CH)

(21) Appl. No.: 19/136,817

(22) PCT Filed: Dec. 7, 2023
(86) PCT No.: PCT/EP2023/084735

§ 371 Date: Jun. 6, 2025

(30) Foreign Application Priority Data
Dec. 8, 2022 (EP) 22212129.5

(51) Int. Cl. G06V 20/69; G02B 21/00; G06V 10/75; G06V 10/82

(52) U.S. Cl. CPC G06V 20/698; G02B 21/008; G06V 10/751; G06V 10/82; G06V 20/693

(57) ABSTRACT

A method for automated microscopic scanning is disclosed. The method comprises the following steps:
a. (110) image data acquisition, wherein the image data acquisition comprises generating microscopic images of a sample by scanning at least one pre-defined scanning area of at least one microscopic slide (128) carrying the sample by using at least one image scanner (122);
b. (112) determining at least one feature characterizing at least one biological entity of the sample by applying at least one classification algorithm to the microscopic images by using at least one processing device, wherein the feature is compared to at least one pre-defined criterion, wherein the determining and the comparing is performed in parallel to the image data acquisition, wherein the image data acquisition of said microscopic slide (128) is discontinued by at least one controlling device of the image scanner (122) as soon as the determined feature reaches the pre-defined criterion; and
c. repeating the method for a next microscopic slide (128).

### TECHNICAL FIELD

The present disclosure relates to a method for automated microscopic scanning, a cell analyzer device, a computer program and computer-readable storage medium. Herein, the devices and methods can be used in the field of whole-slide imaging, preferably in tissue diagnostics and hematology, in particular for digital pathology. However, further uses are feasible.

### BACKGROUND ART

Imaging based hematological cell analyzers accumulate image data that contain images of large numbers of cells. For the task of retrieving cell count values for all relevant cell groups, e.g. white blood cell sub types like neutrophils, monocytes, lymphocytes etc., typically a certain statistical precision requirement is given, e.g. a coefficient of variation (CV). In order to reach such targets a certain minimum number of cells per cell group must be counted for each sample.

Typical imaging workflows foresee to scan a particular slide area which corresponds to a particular sample volume. A scanning area is chosen such that the precision requirements can be fulfilled for all expected samples and cell concentrations therein, including those with the lowest expected occurrences per cell group. Effectively, this can lead to a situation that for many or potentially most samples much larger areas are scanned than would be needed to reach the precision requirements for that particular sample.

On the other hand, microscopic scanning is typically a slow process that requires multiple, partially complicated sub-steps. Speeding up this process would come at the cost of higher complexity or higher performing components, both consequently leading to higher imager module costs.

Therefore, as the scanning area directly reduces imaging throughput, it is highly desirable to scan only as much area as is needed to ensure the required result quality. However, interrupting a scan without compromising result quality is not possible if the cell counts within the scanned areas are not known.

US 2003/0022245 A1 describes a method of assessing pentraxin-binding of particles. The method includes the steps of (a) exposing a biological test sample containing particles that comprise a pentraxin-binding receptor from a test subject to a ligand comprising a pentraxin in the presence of calcium; (b) determining quantitatively the level of binding between particles and ligand in said test sample; and (c) comparing the level of binding in said test sample to the level of binding in a control biological sample containing said particles from a healthy subject of the same species as the subject supplying the test sample. A change in the level of binding in said test sample from that of the control sample is indicative of disease or abnormality.

US 2021/270704 A1 describes the use of automated platforms in the preparation of biomarker-stained cellular samples for microscopic analysis and use of such stained cells in the diagnosis of certain conditions.

US 2020/250396 A1 describes techniques and technologies for automated microscopy scanning systems, wherein a microscopy system performs “hunt mode” operations at coarsely-spaced locations throughout a scanning window until an acceptable quality scan result is achieved. The system then performs detailed scans at all fields of view within a grid cell that includes the location having the acceptable scan result. The system performs another evaluation of the scan results for the entire grid cell, and if the scan results for the grid cell are collectively acceptable, then the system proceeds to perform “scan mode” operations. The scan mode operations include scanning and evaluating all of the fields of view within one or more grid cells adjacent to the acceptable grid cell from the hunt mode operations.

US 2021/264595 A1 describes methods for efficient training of convoluted neural networks using computer-assisted microscope image acquisition and pre-classification of training images for biological objects of interest. The methods combine use of an automated scanning platform, on-the-fly image analysis parallel to the scanning process, and a user interface for review of the pre-classification performed by the software.

### Problem to Be Solved

It is therefore an objective of the present invention to provide a method for automated microscopic scanning, a cell analyzer device, a computer program and computer-readable storage medium, which at least partially avoid the shortcomings of known devices and methods of this kind and which at least partially address the above-mentioned challenges. Specifically, increasing throughput without compromising result quality shall be reached.

### SUMMARY

This problem is addressed by a method and a cell analyzer device for automated microscopic scanning with the features of the independent claims. Advantageous embodiments which might be realized in an isolated fashion or in any arbitrary combinations are listed in the dependent claims as well as throughout the specification.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a method for automated microscopic scanning is proposed.

The method comprises the following method steps which, specifically, may be performed in the given order. Still, a different order is also possible. It is further possible to perform two or more of the method steps fully or partially simultaneously. Further, one or more or even all of the method steps may be performed once or may be performed repeatedly, such as repeated once or several times. Further, the method may comprise additional method steps which are not listed.

The method comprises the following steps:
a. image data acquisition, wherein the image data acquisition comprises generating microscopic images of a sample by scanning at least one pre-defined scanning area of at least one microscopic slide carrying the sample by using at least one image scanner;
b. determining at least one feature characterizing at least one biological entity of the sample by applying at least one classification algorithm to the microscopic images by using at least one processing device, wherein the feature is compared to at least one pre-defined criterion, wherein the determining and the comparing is performed in parallel to the image data acquisition, wherein the image data acquisition of said microscopic slide is discontinued by at least one controlling device of the image scanner as soon as the determined feature reaches the pre-defined criterion;
c. repeating the method for a next microscopic slide.

The automated method according to the invention may provide advantageous means for automated microscopic scanning of a sample, in particular for reducing scan time. The determining and comparing is performed in parallel to the image data acquisition which may further reduce the time required for sample analysis and/or reduce time-to-result or turnaround-time, i.e. the amount of time it takes from ordering the test to reporting the test result to the operator or user. Hence, larger numbers of samples can be processed within a given time period. This may reduce analysis costs. Moreover, imaging quality and homogeneity may be improved since the process is automated. The amount of imaging data that needs to be processed can be reduced. This may be advantageous with regard to processing speed and required computer working memory and/or storage capacity.

The term “automated” as used herein is a broad term and is to be given its ordinary and customary meaning to a person of ordinary skill in the art and is not to be limited to a special or customized meaning. The term may, specifically, refer, without limitation, to a process which is performed completely by means of at least one computer and/or computer network and/or machine, in particular without manual action and/or interaction with a user. The method may be performed completely automatically.

The method may be computer-implemented. The term “computer-implemented” as used herein is a broad term and is to be given its ordinary and customary meaning to a person of ordinary skill in the art and is not to be limited to a special or customized meaning. The term specifically may refer, without limitation, to a process which is fully or partially implemented by using a data processing means, such as data processing means comprising at least one processor. The term “computer”, thus, may generally refer to a device or to a combination or network of devices having at least one data processing means such as at least one processing unit. The computer, additionally, may comprise one or more further components, such as at least one of a data storage device, an electronic interface or a human-machine interface.

The term “microscopic slide” as used herein is a broad term and is to be given its ordinary and customary meaning to a person of ordinary skill in the art and is not to be limited to a special or customized meaning. The term may, specifically, refer, without limitation, to a substrate which is designated for a sample to be mounted on a surface of the microscopic slide. The substrate may be mechanically stable. The substrate may comprise any material which provides sufficient mechanical stability. The substrate may exhibit a surface which is configured to be compatible with biological material. By way of example, the microscopic slide is a glass slide. However, further kinds of materials for the slides may also be feasible.

The microscopic slide may be a plate having a 2D extension and a thickness. The 2D extension of the plate may exhibit a rectangular or circular form. The thickness of the plate may be small compared to a size of the extension, preferably 20%, more preferred 10%, in particular 5%, or less than a measure for a linear extent of the 2D extension of the plate. The microscopic slide may have a shape which may enable imaging of the sample mounted on the microscopic slide.

The term “microscopic scanning” as used herein is a broad term and is to be given its ordinary and customary meaning to a person of ordinary skill in the art and is not to be limited to a special or customized meaning. The term may, specifically, refer, without limitation, to imaging the microscopic slide at a plurality of different x,y-position positions, e.g. at a defined magnification. The term “generating a microscopic image” as used herein is a broad term and is to be given their ordinary and customary meaning to a person of ordinary skill in the art and is not to be limited to a special or customized meaning. The term may, specifically, refer, without limitation, to imaging the microscopic slide at least one image position, e.g. at a defined magnification. The scanning may comprise tile-based scanning and/or line-based scanning.

The x,y-position may be set using at least one xy-stage, e.g. a motorized xy-stage, to move the microscopic slide. As used herein, the term “xy-stage”, is a broad term and is to be given its ordinary and customary meaning to a person of ordinary skill in the art and is not to be limited to a special or customized meaning. The term specifically may refer, without limitation, to a device configured for relative positioning of the microscopic slide and an image sensor. The xy-stage may be connectable with the microscopic slide, e.g. by use of a holder, for relative positioning of the microscopic slide and the image sensor. The xy-stage may be a motorized stage. The xy-stage may be configured for controlling axial movement of the microscopic slide transversal to an optical axis, e.g. in the x,y-plane.

The term “imaging” as used herein is a broad term and is to be given its ordinary and customary meaning to a person of ordinary skill in the art and is not to be limited to a special or customized meaning. The term may, specifically, refer, without limitation, to generating and/or providing a two-dimensional (2D) representation of at least one property of the sample, also denoted by the term “image”. The image can typically, be processed and displayed on a screen for being regarded by eyes of a viewer, preferably, without any further aids, apart from eyeglasses of the viewer. The imaging may comprise generating and/or providing a digital image. The term “digital image” as used herein is a broad term and is to be given its ordinary and customary meaning to a person of ordinary skill in the art and is not to be limited to a special or customized meaning. The term specifically may refer, without limitation, to a discrete and discontinuous representation of the image. The term “digital image” may refer to a two-dimensional function, f(x,y), wherein intensity and/or color values are given for any x,y-position in the digital image, wherein the position may be discretized corresponding to recording pixels of the digital image.

The term “microscopic image” as used herein is a broad term and is to be given its ordinary and customary meaning to a person of ordinary skill in the art and is not to be limited to a special or customized meaning. The term may, specifically, refer, without limitation, to an image of at least one area of the microscopic slide generated by using at least one image scanner, e.g. a scanning microscope. The microscopic scanning may be performed using at least one scanning microscope. The term “image data acquisition” as used herein is a broad term and is to be given its ordinary and customary meaning to a person of ordinary skill in the art and is not to be limited to a special or customized meaning. The term may, specifically, refer, without limitation, to at least one process of generating at least one image, for example a plurality of images. As outline above, the microscopic images may be generated as digital images, e.g. as image data. It is also noted that the method described herein may be used in connection with microscope slide scanning instrument architectures and techniques for image capture, stitching and magnification as described in US 2008/0240613 A1 and U.S. Pat. No. 10,061,107 B2 which are incorporated herein by reference, including features in connection with reconstituting an image.

The term “image scanner” as used herein is a broad term and is to be given its ordinary and customary meaning to a person of ordinary skill in the art and is not to be limited to a special or customized meaning. The term may, specifically, refer, without limitation, to a device or system configured for scanning the sample and thereby generating microscopic images. For example, the image scanner may comprise at least one bright field microscope or at least one fluorescence microscope such as at least one epifluorescence microscope or at least one confocal microscope.

The image scanner may comprise at least one microscope objective. The term “microscope objective” as used herein is a broad term and is to be given its ordinary and customary meaning to a person of ordinary skill in the art and is not to be limited to a special or customized meaning. The term specifically may refer, without limitation, to at least one optical element configured for receiving light generated by the sample in response to illumination and/or light transmitted through the sample and for focusing the impinging light rays to produce an image. The microscope objective may comprise at least one lens, e.g. at least one imaging lens and/or at least one objective lens. The microscope objective may comprise a plurality of lenses such as a lens system. The microscope objective may be configured for receiving at least one incident light beam generated by the sample in response to the illumination. The microscope objective may be configured for generating, e.g. in combination with the imaging lens, an image of the sample on at least one imaging sensor. The microscope objective, e.g. the at least one objective lens, may have a magnification. The magnification may range from 4× to 100×. For example, the magnification may be 20×. The microscope objective may comprise at least one zoom lens and/or at least one zoom lens system.

The image scanner may comprise further optical elements. For example, the image scanner may comprise at least one fluorescence microscope, wherein the fluorescence microscope may comprise further optical elements such as one or more of at least one excitation filter, at least one dichroic mirror, at least one dichroic beam splitter, and at least one emission filter. For example, the image scanner may comprise at least one bright field microscope, wherein the bright field microscope may comprise further optical elements such as at least one condenser lens configured for focusing light from the illumination device onto the sample. Other image scanner may be possible, too. For example, the image scanner may comprise at least one phase contrast microscope.

The image scanner may comprise at least one image sensor. The term “image sensor” as used herein is a broad term and is to be given its ordinary and customary meaning to a person of ordinary skill in the art and is not to be limited to a special or customized meaning. The term specifically may refer, without limitation, to at least one sensor device having at least one imaging element configured for recording or capturing spatially resolved one-dimensional, two-dimensional or even three-dimensional optical data or information. The image sensor may be a camera, e.g. a pixelated camera. As an example, the imaging sensor may comprise at least one camera chip, such as at least one CCD chip and/or at least one CMOS chip. The image sensor may comprise at least one camera, wherein the camera is a charge-coupled device (CCD) and/or a complimentary metal-oxide semiconductor (CMOS) image sensor. However, further kinds of imaging devices may also be feasible.

The method, in step a), may comprise illuminating at least partially the microscopic slide by using at least one illumination device. The term “illumination device” as used herein is a broad term and is to be given its ordinary and customary meaning to a person of ordinary skill in the art and is not to be limited to a special or customized meaning. The term specifically may refer, without limitation, to an arbitrary device configured for emitting light, such as one or more of light in the visible spectral range, the light in the infrared spectral range or light in the ultraviolet spectral range. The term “at least partially illuminating” as used herein is a broad term and is to be given its ordinary and customary meaning to a person of ordinary skill in the art and is not to be limited to a special or customized meaning. The term specifically may refer, without limitation, to embodiments in which the whole microscopic slide is illuminated and to embodiments in which subportions of the microscopic slide, e.g. a scanning area, are illuminated. The illumination device may be configured for emitting light having a single wavelength or may be configured for simultaneously emitting light having different wavelength. Other options, however, are also feasible. The illumination device may comprise at least one light source. The illumination device may comprise additional elements such as at least one condenser and/or optical elements for setting a direction of propagation of the light beam generated by the light source. The condenser may comprise at least one optical lens configured for transforming a divergent light beam from the light source into a parallel or converging light beam.

For example, the image scanner may comprise at least one bright field microscope. The illumination of the sample may comprise transillumination of the slide. The illumination may be arranged for transmission through the slide or reflection from the slide. The microscopic slide may be arranged between the illumination device and the microscope objective. The illumination device of the bright field microscope may be at least one illumination light source, e.g. a halogen lamp, an incandescent light source or a light emitting diode (LED). For example, light in the spectral range from 400 nm to 800 nm may be used. The sample disposed on the microscopic slide may generate, e.g. emit, in response to the illumination at least one light beam such as by transmission. The light beam emitted in response to the illumination may be at least one signal emitted in response to illumination in the visible spectral range. The sample may be stained to increase color differentiation and contrast. The emitted signal may be color pattern and/or attenuation of the transmitted light. The wavelength range of the illumination light source may span the full range from ultraviolet (<400 nm) to infrared light (>800 nm). Additionally the wavelength range of the illumination light source may span only one or multiple limited wavelength ranges e.g. from monochrome LEDs or as result of placing spectral band pass filters.

For example, the image scanner comprises at least one fluorescence microscope, wherein the illumination device may comprise one or more of at least one xenon arc lamp, at least one mercury-vapor lamp, at least one LED, or at least one laser light source. The illumination device may be configured for illuminating of the sample with illumination light which is absorbed by fluorophores of the sample, causing them to emit light. The emitted light, e.g. the emitted signal, may be of a different wavelength(s) than that of the illumination light. The emitted signal may be a fluorescence signal. The wavelength range of the illumination light source may span the full range from ultraviolet (<400 nm) to infrared light (>800 nm). Additionally the wavelength range of the illumination light source may span only one or multiple limited wavelength ranges e.g. from monochrome LEDs or as result of placing spectral band pass filters. The spectral bands of illumination light can be confined to narrow bands of e.g. 10-100 nm, with center wavelengths ranging from <300 to >900 nm.

As used herein, the term “ray” generally refers to a line that is perpendicular to wavefronts of light which points in a direction of energy flow. As used herein, the term “beam” generally refers to a collection of rays. In the following, the terms “ray” and “beam” will be used as synonyms. As further used herein, the term “light beam” generally refers to an amount of light, specifically an amount of light traveling essentially in the same direction, including the possibility of the light beam having a spreading angle or widening angle.

The term “scanning area” as used herein is a broad term and is to be given its ordinary and customary meaning to a person of ordinary skill in the art and is not to be limited to a special or customized meaning. The term specifically may refer, without limitation, to a region of the microscopic slide that comprises at least a portion of the sample. The scanning area is pre-defined. For example, the scanning may be pre-defined automatically and/or manually. The method may comprise predefining the scanning area. The scanning area may pre-defined by using information retrieved from other cell differentiation modules or analyzers, e.g. such as from flow cytometers.

The scanning area may be divided into a plurality of sub-regions. The image scanner may be configured for illuminating and imaging the sub-regions subsequently, e.g. by moving the microscopic slide in x,y direction, thereby generating microscopic images. The image scanner may be configured for autonomously adjusting a microscope focus and lightning conditions.

The method may comprise transferring image data to at least one digital storage. The imaging scanner may comprise at least one communication interface. The term “communication interface” as used herein is a broad term and is to be given its ordinary and customary meaning to a person of ordinary skill in the art and is not to be limited to a special or customized meaning. The term specifically may refer, without limitation, to an item or element forming a boundary configured for transferring information. The communication interface may be configured for transferring information from a computational device, e.g. a computer, such as to send or output information, e.g. onto another device. Additionally or alternatively, the communication interface may be configured for transferring information onto a computational device, e.g. onto a computer, such as to receive information. The communication interface may specifically provide means for transferring or exchanging information. The communication interface may provide a data transfer connection, e.g. Bluetooth, NFC, USB such as USB 2.0, USB 3, USB 4 and the like, inductive coupling or the like. As an example, the communication interface may be or may comprise at least one port comprising one or more of a network or internet port, a USB-port and a disk drive. The communication interface may further comprise at least one display device. The communication interface may be at least one web interface. The term “digital storage” as used herein is a broad term and is to be given its ordinary and customary meaning to a person of ordinary skill in the art and is not to be limited to a special or customized meaning. The term specifically may refer, without limitation, to at least one database. The digital storage may contain an arbitrary collection of information. The digital storage may be or may comprise at least one database selected from the group consisting of: at least one server, at least one server system comprising a plurality of servers, at least one cloud server or cloud computing infrastructure. The digital storage may comprise at least one storage unit configured to store data.

The method may comprise automatic scanning of the microscopic slide. The image scanner may be configured for autonomously scanning the microscopic slide. The image scanner may comprise at least one slide receptacle configured for receiving the microscopic slide. The image scanner may be configured for detecting a presence of a microscopic slide in the receptacle. The image scanner, e.g. the controlling device, may be configured for starting a chain of processes when detecting a microscopic slide in the receptacle. The image scanner may comprise means for providing the microscopic slide to an imaging position, e.g. at least one stage, e.g. the XY-moving stage, and/or at least one gripping device. The image scanner may be configured for moving the microscopic slide in lateral (x-y) direction, e.g. by using the xy-stage.

The method may comprise automatic scanning a plurality of microscopic slides. The image scanner may receive the microscopic slides one after the other. Other embodiments are feasible. For example, the image scanner may receive the microscopic slides at the same time, e.g. by using a rack. The image scanner may comprise at least one slide buffer. The term “slide buffer” is a broad term and is to be given its ordinary and customary meaning to a person of ordinary skill in the art and is not to be limited to a special or customized meaning. The term specifically may refer, without limitation, to a storage device configured for receiving and storing a plurality of microscopic slides, e.g. for subsequent processing. The image scanner may be configured for storing the microscopic slides into the slide buffer. The image scanner may be configured for storing the microscopic slides into the slide buffer before microscopic scanning. The image scanner may be configured for transferring the microscopic slide after image scanning into a slide buffer, e.g. back into the slide buffer or into a further slide buffer, e.g. for further processing. The automatic scanning may comprise one or more of receiving the microscopic slides, providing the microscopic slides to the imaging position, storing the microscopic slides in a slide buffer, scanning the microscopic slides, applying at least one further workflow to the microscopic slides subsequent to scanning. The complete chain of processes from receiving to scanning or even the further workflow to the microscopic slides subsequent to scanning may be performed automatically, e.g. by using the controlling device of the image scanner. The process chain may, however, comprise manual steps, such as for loading the slide, correction of the imaging position and the like.

The image scanner comprises at least one controlling device. The controlling device may be configured for controlling the image scanner, such as at least one element or unit of the image scanner. For example, the controlling device may be configured for controlling the imaging of the image sensor. The controlling device may be connected to the image sensor. For example, the controlling device may be configured for controlling providing the microscopic slide to the imaging position. The controlling device may be connected to the gripper device and/or the stage. For example, the controlling device may be configured for controlling buffering of the microscopic slides in the slide buffer. For example, the controlling device may be configured for controlling transferring image data to at least one digital storage. The term “controlling device” as used herein is a broad term and is to be given its ordinary and customary meaning to a person of ordinary skill in the art and is not to be limited to a special or customized meaning. The term may, specifically, refer, without limitation, to an arbitrary device configured for performing the named operations, e.g. by using at least one data processing device, e.g. the processing device described above or as described in more detail below, and, for example, by using at least one processor and/or at least one application-specific integrated circuit. As an example, the at least one controlling device may comprise at least one data processing device having a software code stored thereon comprising a number of computer commands. The controlling device may provide one or more hardware elements for performing one or more of the named operations and/or may provide one or more processors with software running thereon for performing one or more of the named operations. The controlling device may comprise one or more programmable devices such as one or more computers, application-specific integrated circuits (ASICs), Digital Signal Processors (DSPs), or Field Programmable Gate Arrays (FPGAs). Additionally or alternatively, however, the controlling device may also fully or partially be embodied by hardware. Further, the controlling device may comprise at least one volatile or non-volatile data storage. The controlling device may comprise at least one interface, such as a human-device interface, configured for entering commands and/or for outputting information. The at least one interface may comprise a wired interface and/or a wireless interface for unidirectionally or bidirectionally exchanging data or commands, specifically between the image scanner and at least one further device and/or units of the image scanner. For example, the controlling device may comprise at least one computer and/or at least one processor. The controlling device may be or may comprise a centralized control device and/or one or more decentralized control devices.

The term “sample” as used herein is a broad term and is to be given its ordinary and customary meaning to a person of ordinary skill in the art and is not to be limited to a special or customized meaning. The term specifically may refer, without limitation, to a liquid sample suspected to comprise at least one biological entity. Typically, the “sample” refers to a liquid sample. More typically, the term “sample” may refer to an arbitrary type of body fluid, a sample from a tissue or an organ, or a sample of wash/rinse fluid or a swab or smear obtained, from an outer or inner body surface. Still more typically the term “sample” refers to a whole blood preparation. The sample may be suspected to comprise at least one biological entity as specified elsewhere herein, or the sample, specifically comprises at least one biological entity as specified elsewhere herein. The sample may be a liquid sample obtained from, for example, a body fluid such as blood, plasma, serum, urine, saliva, or lacrimal fluid sample, or a synovial, pleural or cerebrospinal fluid or tissue preparation. The sample may be a preparation of whole blood, or a preparation of a body fluid like synovial, pleural or cerebrospinal fluid or tissue. “Blood” and other body fluids referred to herein may typically refer to the blood or body fluid of a human. However, blood and body fluids of other vertebrates may also be used as a sample.

Samples typically can be obtained by use of brushes, (cotton) swabs, spatula, rinse/wash fluids, punch biopsy devices, puncture of cavities or tissues including arteria and veins with needles or lancets, or by surgical instrumentation. However, samples obtained by well-known techniques including, in particular, scrapes, swabs or biopsies from the urogenital tract, perianal regions, anal canal, the oral cavity, the upper aerodigestive tract and the epidermis may also be included as samples of the present invention. Typically, samples are blood samples obtained by arterial sampling; venipuncture sampling; fingerstick sampling. Liquid samples may be obtainable by dissolving, suspending or dispersing a sample in an appropriate liquid including water as known by the skilled artisan. Typically, the sample may be heterogeneous to a certain degree, for example containing cells of human origin or parasitic origin or cell groups in a biological medium such as serum or plasma, or in an artificial medium, such as a buffer solution.

The term “biological entity” as used herein is a broad term and is to be given its ordinary and customary meaning to a person of ordinary skill in the art and is not to be limited to a special or customized meaning. The term specifically may refer, without limitation, to any type of biological object that can be detected and/or optically resolved by using optical microscopy. The biological entity may have a size in the range of a few hundred nanometers to several micrometers, for example 100 nm to 100 μm. Typically, the resolution limit of an optical microscope lies in the range of about 180 nm to 400 nm depending on the type of microscope used. The biological entity may be selected from the group consisting of: a cell type, a cell group, a virus, an extracellular structure. The biological entity as referred being subjected to microscopic imaging can emit a signal suitable for determining the abundance of the biological entity.

The term “at least one feature characterizing at least one biological entity of the sample” is a broad term and is to be given its ordinary and customary meaning to a person of ordinary skill in the art and is not to be limited to a special or customized meaning. The at least one feature characterizing at least one biological entity of the sample may specifically, without limitation, be a quantitative feature indicative for the abundance of the biological entity, such as for example an accumulated count of the biological entity. Alternatively or additionally, the quantitative feature indicative for the abundance of the biological entity may relate to cell count, cellular volume, cell distribution width, cell appearance and/or cell fraction. Cell appearance may relate to color detection in gray scale. The feature may be an accumulated cell count for a cell type of interest or a cell group of interest; an accumulated count of a virus of interest; and an accumulated count of an extracellular structure of interest. The term “accumulated cell count” or “accumulated count” as used herein is a broad term and is to be given its ordinary and customary meaning to a person of ordinary skill in the art and is not to be limited to a special or customized meaning. The term specifically may refer, without limitation, to the number of cells or biological entities counted during a pre-defined range of time or within a pre-defined area.

The term “cell type” is a broad term and is to be given its ordinary and customary meaning to a person of ordinary skill in the art and is not to be limited to a special or customized meaning. The term specifically may refer, without limitation, to a classification used to identify cells that share morphological or phenotypical features. Typically, cell types of all kinds of cells can be classified based on morphological or phenotypical features including prokaryotic and eukaryotic cells. For example, cells of unicellular organisms such as bacterial, archeabacterial and some fungal cells, and cells of multicellular organisms including protozoa, chromista, plants, fungi and animals may be classified into different types. In the human body, cells may generally be classified into cell types depending on the germline of origin, such as endodermal cell types, ectodermal and mesodermal cell types. Typical human cell types include for example exocrine secretory epithelial cells, epithelia cells, mesothelial cells, barrier cells, hormone-secreting cells, oral cells, neurons, secretory cells, germ cells, muscle cells, blood cells, immune cells, interstitial cells, extra cellular matrix cells. In line with the present invention, a “cell type” can be classified by applying the at least one classification algorithm specified herein.

The term “cell type” may more specifically relate to blood cells and cells present in blood preparations, in particular to white blood cells, red blood cells, platelets; cells of parasites present in the blood; bacterial cells present in the blood; cancer cells; or mesothelial cells. Typical parasites present in the blood are for example protozoan parasite. More particularly, parasites present in the blood may be Plasmodium species including P. vivax, P. falciparum, P. malariae, P. ovale, and P. knowlesi; Trypanosomatida species including Trypanosoma. brucei, Trypanosoma. cruzi, and Leishmania species; Toxoplasmatinae species like Toxoplasma gondii; Babesia species;

Typical bacteria and cells thereof that may be present in blood include species of Staphylococcus, Streptococcus species such as Streptococcus pyogenes, Pseudomonas species such as Pseudomonas aeruginosa, Haemophilus species, Clostridium difficile, Escherichia coli, Borrelia such as Borrelia burgdorferi and Klebsiella species.

The term “cell group” is a broad term and is to be given its ordinary and customary meaning to a person of ordinary skill in the art and is not to be limited to a special or customized meaning. The term specifically may refer, without limitation, to a number of cells of one or, typically, more than one cell type and/or subtype comprising at least one common feature, such as a morphological feature. Typically, the at least one common feature is or relates to a feature characterizing cells of said cell group. More typically, said feature can be used to determine a cell as a member of said cell group. Even more typically, said feature can be used to distinguish a cell of said cell group from other cells.

The term “cell group of interest” as used herein is a broad term and is to be given its ordinary and customary meaning to a person of ordinary skill in the art and is not to be limited to a special or customized meaning. The term specifically may refer, without limitation, to the cell group characterized by the determined feature. The cell group of interest may be suspected to be comprised in the at least one biological entity in the sample. Further details are defined elsewhere herein.

The cell group may be selected from the group consisting of:
(i)white blood cell sub types such as neutrophils, lymphocytes; atypical lymphocytes; hematopoietic progenitor cells; monocytes; immature granulo-cytes; granulocytes including basophils, eosinophils, neutrophils such as segmented neutrophils and band neutrophils, mast cells; blasts; promyelocytes; metamyelocytes; myelocytes; neutrophils segmented neutrophils, band neutrophils, plasma cells; variant lymphocytes; Pelger-Huet cells; smudge cells; hyper granulated cells; damaged white blood cells; white blood cells with inclusions like Auer rods or Doehle bodies;
(ii)red blood cell subtypes like normal erythrocytes; nucleated red blood cells; polychromatic cells; Poikilocytes like sickle cells; Burr-cells; teardrop shaped; ovalocytes; target cells; helmet cells; reticulocytes, immature reticulocytes; schistocytes; spherocytes; stomatocytes; unusual red blood cells such as in the case of anisocytosis, hypochromasia, macrocytosis, microcytosis, poikilocytosis, or polychromasia; red blood cells with inclusions like Howell-Jolly bodies, Heinz bodies, Pappenheimer bodies, basophilic stipplings, cabot ring, hemoglobin clumps; red blood cells with parasitic inclusions like plasmodia or babesia;
(iii)platelet subtypes like normal platelets, giant platelets, megakaryocytes, reticulated platelets;
(iv)other cells, cell types or cell subtypes such as mesothelial cells; cell clusters; cancer cells; extracellular parasites; bacteria; bacteria-infected cells; virus-infected cells; cells with inclusions; cells with intracellular structures.

The term “extracellular structure” as used herein is a broad term and is to be given its ordinary and customary meaning to a person of ordinary skill in the art and is not to be limited to a special or customized meaning. The term specifically may refer, without limitation, to any structure present in the sample that is not inside a cell. An extracellular structure may refer to extracellular crystals; artefacts; and the like. Artefacts may particularly relate to products of staining dye precipitation like eosin and methylene blue. Extracellular crystals may specifically refer to crystals occurring in synovial fluids or urine. Crystals in synovial fluids particularly include monosodium urate monohydrate (MSUM) and calcium pyrophosphate dihydrate (CPPD) crystals, cholesterol and other lipid particles and the basic calcium phosphates (BCPs), including apatites. Crystals in urine typically include crystals of uric acid, cysteine, calcium oxalate, calcium carbonate, struvite and the like.

The term “virus” as used herein is a broad term and is to be given its ordinary and customary meaning to a person of ordinary skill in the art and is not to be limited to a special or customized meaning. The term specifically may refer, without limitation, to any known virus; in particular to any known human pathogenic virus including coronavirus, e.g. SARS-COV2; herpes virus; rhinovirus; HIV; norovirus; influenza virus; Eppstein-Barr virus.

The method may further comprise at least one sample preparation step. The sample preparation step may comprise at least one action selected from the group consisting of: dissolving, suspending or dispersing a sample in an appropriate liquid; applying a sample to the microscopic slide; staining the sample.

The dissolving, suspending or dispersing of the sample may be performed in water or an appropriate buffer such as PBS (phosphate-buffer saline), physiological sodium chloride solution or other buffers known to the skilled artisan. Typically the sample is prepared by dissolving, suspending or dispersing of the sample to obtain a liquid sample.

Staining of the sample may be done by procedures known in the art. Typical staining procedures for microscopy include Gram-staining; staining with at least one of the following staining solutions, or dyes: coumarin, crystal violet, cyanine, DAPI, eosin, fluorescein, fuchsin, Giemsa-staining, hematoxylin, malachite green, methylene blue, osmium tetroxide, rhodamine, safranin. The staining may be performed by submerging the sample in the staining solution prior to the mounting or applying of the sample to the microscopic slide by procedures known in the art. Alternatively, the stain may be added onto the sample when already mounted on/applied to the microscopic slide; such means and methods are also known in the art.

The sample may be applied to the microscopic slide by using at least one printing technique. The applying the sample to the microscopic slide may comprise dispensing a known volume of sample by an applicator in two or more rows over an area of the substrate to form a monolayer of the biological entity, e.g. of blood cells. The layer may be a single layer of the biological entity, specifically am monolayer, typically of blood cells or other cells of the cell group of interest, in height, also referred to as Z-direction, present on the surface of the microscopic slide. For example, a printing technique as described in U.S. Pat. Nos. 9,017,610 B2, 10,094,764 B2 or 8,815,537 B2, which are incorporated herein by reference, may be used. Typically, a suitable amount or a suitable volume of the sample is applied to the microscopic slide, e.g. by using said at least one printing technique or by dispensing. In the case of a liquid sample, a suitable volume to be applied to the microscopic slide may be in the range of 0.01 to 10 μl, typically 0.1 μl to 1 μl. Alternatively, conventional wedge smear techniques as known in the art may be used, such as performed by a commercially available system e.g. a Sysmex SP-50 system (Sysmex Deutschland GmBH).

Typically pre-defined volumes of a sample, such as 0.5 μl or 1 μl, are dispensed or distributed onto the surface of a microscopic slide. More typically, said volumes are dispensed or distributed in a way such that the ratio volume/slide area is constant. For example, 1.0 μl per 440 mm² or 0.5 μl per 220 mm².

The term “processing device” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. The processing device may be configured for processing basic instructions that drive the computer or system. As an example, the processing device may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. The processing device may be a multi-core processor. The processing device may be or may comprise a central processing unit (CPU). Additionally or alternatively, the processing device may be or may comprise a microprocessor. The processing device's elements may be contained in one single integrated circuitry (IC) chip. Additionally or alternatively, the processing device may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The processing device specifically may be configured, such as by software programming, for performing one or more evaluation operations. For example, the processing device is a control logic of the image scanner and/or a remote device to which the image scanner is connected. The processing device may be at least one element or at least one unit of the image scanner. However, other embodiments are feasible, e.g. in which the processing device is embodied at least partially as external and/or remote processing device.

The at least one feature characterizing the biological entity may be determined by measuring the presence, absence and/or intensity of a signal emitted by the biological entity. As outlined above, said signal may be selected from the group consisting of: a fluorescence signal and a signal emitted in response to illumination in a visible spectral range.

The term “classification” as used herein is a broad term and is to be given its ordinary and customary meaning to a person of ordinary skill in the art and is not to be limited to a special or customized meaning. The term specifically may refer, without limitation, to a process of categorizing features of the microscopic image into at least two categories, such as a feature relating to the biological entity of interest or another feature. The classification may be a differentiation. The term “classification algorithm” as used herein is a broad term and is to be given its ordinary and customary meaning to a person of ordinary skill in the art and is not to be limited to a special or customized meaning. The term specifically may refer, without limitation, to at least one algorithm designed for performing the classification. The classification algorithm may use at least one parametric model or at least one non-parametric model. The classification algorithm may take the microscopic images and/or features extracted from the microscopic images as input. For example, the extracted features may be shape and/or color statistics. The classification algorithm may use at least one classification algorithm selected from the group consisting of: at least one convolutional neural network (CNN) technology, deconvolutional neural network (DNN) technology, decision trees, point vector, at least one transformer based model, random forest, K-Nearest-Neighbor, and the like.

The classification algorithm may comprise at least one trained machine learning model. The term “machine learning model” as used herein is a broad term and is to be given its ordinary and customary meaning to a person of ordinary skill in the art and is not to be limited to a special or customized meaning. The term specifically may refer, without limitation, to a mathematical model which is trainable on at least one training dataset using machine learning, in particular deep learning or other form of artificial intelligence. The term “machine learning” as used herein is a broad term and is to be given its ordinary and customary meaning to a person of ordinary skill in the art and is not to be limited to a special or customized meaning. The term specifically may refer, without limitation, to a method of using artificial intelligence (AI) for automatically model building. The method may comprise at least one training step. The training step may comprise training the machine learning model based on the training dataset. The term “training” as used herein is a broad term and is to be given its ordinary and customary meaning to a person of ordinary skill in the art and is not to be limited to a special or customized meaning. The term specifically may refer, without limitation, to a process of building the trained machine learning model, in particular determining parameters, in particular weights, of the model. The training may comprise determining and/or updating parameters of the model. The trained machine learning model may be at least partially data driven. As used herein, the term “at least partially data-driven” is a broad term and is to be given its ordinary and customary meaning to a person of ordinary skill in the art and is not to be limited to a special or customized meaning. The term specifically may refer, without limitation, to the fact that the model comprises data-driven model parts. The model may comprise additional other model parts such as based on physico-chemical laws. The training may be performed on historical microscopic images. The training dataset may be generated by manual classification of the features of the historical microscopic images, e.g. into at least two categories.

After classification, the respective features of the microscopic image classified as to relate to the biological entity of interest may be tracked. The method may comprise successively adding up and/or counting the respective classified features of the microscopic image classified as to relate to the biological entity of interest thereby determining the feature characterizing said biological entity of interest, e.g. an accumulated cell count.

The feature characterizing at least one biological entity of the sample is compared to at least one pre-defined criterion. The term “pre-defined criterion” as used herein is a broad term and is to be given its ordinary and customary meaning to a person of ordinary skill in the art and is not to be limited to a special or customized meaning. The term specifically may refer, without limitation, to a pre-set or pre-defined value of the at least one feature characterizing at least one biological entity. The pre-defined criterion can vary between cell types and can have different purposes. For example, the pre-defined criterion may be a pre-defined or pre-set count of the accumulated count of biological entity. E.g. the pre-defined criterion may relate to a minimum number of cells that needs to be found to ensure a certain statistical significance of the count result. In particular, a number of at least 1100 white blood cells (WBCs) to achieve a coefficient of variation (CV) better than 3%.

The step comparing of the feature characterizing at least one biological entity of the sample to the at least one pre-defined criterion in particular may have the advantage that it ensures a homogenous quality of the image data acquisition, e.g. based on the pre-defined criterion. Thereby also the homogeneity of the image data may be increased, which may e.g. decrease inter-sample variability.

In particular, the pre-defined criterion may relate to an accumulated count of a cell type of interest. For example to an accumulated count of a white blood cell (WBC) in whole blood. With respect to WBCs, the pre-defined criterion may relate to an accumulated count of at least 1100 WBCs or subtypes thereof. With respect to red blood cells (RBCs) or platelets, the pre-defined criterion may relate to a pre-defined accumulated count of RBCs or platelets or subtypes thereof.

The determining of the feature and the comparing is performed in parallel to the image data acquisition. The term “performed in parallel” as used herein is a broad term and is to be given its ordinary and customary meaning to a person of ordinary skill in the art and is not to be limited to a special or customized meaning. The term specifically may refer, without limitation, to running the classification algorithm and performing the comparison during image data acquisition. For example, the running the classification algorithm and performing the comparison may start as soon as the first microscopic image or a pre-defined number of microscopic images is generated, e.g. as soon as the image data is available on the digital storage. The processing device may be configured for running the classification algorithm in parallel to image acquisition. By comparing the feature to the pre-defined criterion, e.g. the accumulated cell counts per cell group of interest, the image scanner can be controlled in order to insure consistent count data quality across cell groups and samples. The pre-defined criterion can vary between cell types and can have different purposes. E.g. a minimum number of cells needs to be found to ensure a certain statistical significance of the count result (e.g. >1100 WBCs to achieve a CV better than 3%).

The image data acquisition of said microscopic slide is discontinued by the controlling device of the image scanner as soon as the determined feature reaches the pre-defined criterion. The term “discontinue” as used herein is a broad term and is to be given its ordinary and customary meaning to a person of ordinary skill in the art and is not to be limited to a special or customized meaning. The term specifically may refer, without limitation, to a process of terminating and/or interrupting the image data acquisition. For example, as soon as the determined feature reaches the pre-defined criterion, the controlling device may trigger to terminate the image data acquisition. After comparison to predefined target count values a decision may be made by the controlling device whether to continue or interrupt the scanning. For example, as soon as sufficiently large numbers of cells were identified for all relevant cell groups, the image scanner can discontinue the image acquisition and can proceed to the next sample. The classification results may be available with a certain delay. However, the image scanner and/or processing device may be configured for providing the classification results sufficiently fast such that controlling of the imager scanner is effective and an increase of throughput can be achieved. If the scanning can stop early, subsequent samples can be processed earlier, thereby increasing the throughput.

For example, step b) may comprise classifying and counting cells of at least one cell group of interest by applying at least one cell classification algorithm to the microscopic images by using the processing device. An accumulated cell count per cell group of interest may be determined by the processing device. The classification and counting is performed in parallel to the image data acquisition. The image data acquisition of said microscopic slide may be discontinued by at least one controlling device of the image scanner as soon as the determined accumulated cell count of the cell group of interest reaches a pre-defined minimum cell count of the respective cell group of interest.

For example, the method comprises classifying and counting cells of a plurality of cell groups of interest. An accumulated cell count per cell group of interest may be determined. The image data acquisition of said microscopic slide may be discontinued as soon as the determined accumulated cell counts of the cell groups of interest reach the pre-defined minimum cell count of the respective cell group of interest and the repeating method for a next microscopic slide.

The method may comprise adapting the scanning area of the microscopic slide by using the controlling device in case the determined feature characterizing at least one biological entity of the sample fails to fulfill the pre-defined criterion after scanning the pre-defined scanning area. The pre-defined scanning area may be a standard scan area, which may be pre-defined by the manufacturer or may be pre-defined by the user before operation of the image scanner. The adapting may comprise increasing the scanning area. The image scanner may prolong image data acquisition and determining the feature characterizing at least one biological entity of the sample until the pre-defined criterion is reached. As outlined above, the pre-defined criterion may be used for ensuring a certain statistical significance of the result. In case the feature characterizing at least one biological entity does not exceed the pre-defined criterion within a standard scan area, the standard scan area may be adapted. The controlling device may be configured for adapting, e.g. increasing the scanning area, up to a pre-defined maximum scanning area. The maximum scanning area may be pre-defined in view of time constrains.

For example, the method comprises adapting the scanning area of the microscopic slide by using the controlling device in case the determined accumulated cell counts of the cell groups of interest are below the respective pre-defined minimum cell count of the respective cell group of interest after scanning the pre-defined scanning area. The image scanner may prolong image data acquisition, classifying and counting cells until for each cell group of interest the pre-defined minimum cell count of the respective cell group of interest is reached.

The method may comprise adapting the scanning area of the microscopic slide by using the controlling device in case a pre-defined number of abnormalities is determined. The pre-defined number of abnormalities may be a low single digit number, e.g. 1. The classification may exhibit abnormal cell types. If an associated count result does exceed a pre-defined number, an adaption, e.g. increase, of the scanning area can be triggered.

The method may comprise performing at least one workflow subsequent to discontinuing of the image data acquisition. For example, the workflow comprises one or more of further processing, storage, wasting, sample aspiration, slide preparation, slide staining. The further processing can include washing and re-staining of the slide. The workflow may further comprise one or more of sample re-testing, reflex testing e.g. based on the acquired test result and/or triggering a subsequent test on another instrument or module.

The method may comprise at least one fail safe step. The term “fail safe step” as used herein is a broad term and is to be given its ordinary and customary meaning to a person of ordinary skill in the art and is not to be limited to a special or customized meaning. The term specifically may refer, without limitation, to at least one step ensuring to prevent generating and/or determining and/or displaying unreliable or even false measurement values. The method may comprise determining artefacts, e.g. by using the classification algorithm. The fail safe step may be triggered depending on the determined artefacts, e.g. a presence of artefacts and/or an amount of artefacts. Artefacts may potentially occur due to aberrations in the sample or aberrations in the slide. For example, certain types of artefacts may indicate stain precipitations or morphological deviations which are known to originate from defective slide or sample preparation. This can be lysed or otherwise damaged cells, pieces or fragments thereof. It may also relate to damage of the slide itself, including damage of the slide material, particular the surface. For example, in case of determining artefacts, processing of method steps a) and b) may be stopped and/or the image data be rejected and/or the microscopic slide may be rejected for use or further use. At least one failsafe decision may be determined and/or at least one failsafe action may be performed. For example, the failsafe step may comprise issuing and/or displaying an error message. The failsafe step may comprise displaying a warning message. For example, the failsafe step may comprise preventing issuing and/or displaying a measurement result. For example, the failsafe step may comprise a request to remove the microscopic slide. The failsafe step may be performed repeatedly, e.g. in parallel to image acquisition.

In a further aspect of the present invention, a cell analyzer device configured for performing a method according to the present invention is proposed. With respect to definitions and embodiments of the cell analyzer device reference is made to the description of the method above or as given in more detail below.

The cell analyzer comprises
at least one image scanner configured for image data acquisition, wherein the image data acquisition comprises generating microscopic images by scanning at least one pre-defined scanning area of at least one microscopic slide;
at least one processing device configured for determining at least one feature characterizing at least one biological entity of the sample by applying at least one classification algorithm to the microscopic images, wherein the processing device is configured for comparing the feature characterizing at least one biological entity of the sample to at least one pre-defined criterion, wherein the processing device is configured for performing the determining and the comparing in parallel to the image data acquisition performed by the image scanner;
at least one controlling device configured for discontinuing the image data acquisition of said microscopic slide as soon as the determined feature reaches the pre-defined criterion, and to continue with image data acquisition of a next microscopic slide.

Further disclosed and proposed herein is a computer program including computer-executable instructions for performing the method according to the present invention in one or more of the embodiments enclosed herein when the instructions are executed on a computer or computer network. Specifically, the computer program may be stored on a computer-readable data carrier and/or on a computer-readable storage medium. The computer program comprises instructions which, when the program is executed by the cell analyzer device according to the present invention, cause the cell analyzer device to perform the method according to the present invention.

Furthermore, the present invention contemplates a computer-readable storage medium comprising instructions which, when the instructions are executed by the cell analyzer device according to the present invention, cause the cell analyzer device to perform the method according to the present invention.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps a) to b) as indicated above may be performed by using a computer or a computer network, preferably by using a computer program.

Further disclosed and proposed herein is a computer program product having program code means, in order to perform the method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Still further, the present invention relates to a non-transient computer-readable medium including instructions that, when executed by one or more processors, cause the one or more processors to perform the method according to the present invention.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network. Finally, disclosed and proposed herein is a modulated data signal which contains instructions readable by a computer system or computer network, for performing the method according to one or more of the embodiments disclosed herein.

Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

Summarizing and without excluding further possible embodiments, the following embodiments may be envisaged:

Embodiment 1. A method for automated microscopic scanning comprising the following steps:
a. image data acquisition, wherein the image data acquisition comprises generating microscopic images of a sample by scanning at least one pre-defined scanning area of at least one microscopic slide carrying the sample by using at least one image scanner;
b. determining at least one feature characterizing at least one biological entity of the sample by applying at least one classification algorithm to the microscopic images by using at least one processing device, wherein the feature is compared to at least one pre-defined criterion, wherein the determining and the comparing is performed in parallel to the image data acquisition, wherein the image data acquisition of said microscopic slide is discontinued by at least one controlling device of the image scanner as soon as the determined feature reaches the pre-defined criterion; and
c. repeating the method for a next microscopic slide.

Embodiment 2. The method according to the preceding embodiment, wherein the feature characterizing at least one biological entity of the sample is a quantitative feature indicative for the abundance of the biological entity in said sample.

Embodiment 3. The method according to any one of the preceding embodiments, wherein the at least one biological entity of the sample is selected from the group consisting of: a cell type, a cell group, a virus, and an extracellular structure.

Embodiment 4. The method according to one of the preceding embodiments, wherein said feature characterizing the at least one biological entity of the sample is at least one feature selected from the group consisting of: an accumulated cell count for a cell type of interest or a cell group of interest; an accumulated count of virus of interest; and an accumulated count of an extracellular structure of interest.

Embodiment 5. The method of any one of the preceding embodiments, wherein the at least one feature characterizing the biological entity is determined by measuring the presence, absence and/or intensity of a signal emitted by the biological entity.

Embodiment 6. The method of embodiment 5, wherein said signal is selected from the group consisting of: a fluorescence signal and a signal emitted in response to illumination in a visible spectral range.

Embodiment 7. The method according to any one of the preceding embodiments, wherein step b) comprises classifying and counting cells of at least one cell group of interest by applying at least one cell classification algorithm to the microscopic images by using the processing device, wherein an accumulated cell count per cell group of interest is determined by the processing device, wherein the classification and counting is performed in parallel to the image data acquisition, wherein the image data acquisition of said microscopic slide is discontinued by at least one controlling device of the image scanner as soon as the determined accumulated cell count of the cell group of interest reaches a pre-defined minimum cell count of the respective cell group of interest.

Embodiment 8. The method according to any one the preceding embodiments, wherein the method comprises adapting the scanning area of the microscopic slide by using the controlling device in case the determined feature characterizing at least one biological entity of the sample fails to fulfill the pre-defined criterion after scanning the pre-defined scanning area, wherein the image scanner prolongs image data acquisition and determining the feature characterizing at least one biological entity of the sample until the pre-defined criterion is reached.

Embodiment 9. The method according to any one of the preceding embodiments, wherein the classification algorithm uses at least one classification algorithm selected from the group consisting of: at least one convolutional neural network (CNN) technology, deconvolutional neural network (DNN) technology, decision trees, point vector, random forest, K-Nearest-Neighbor.

Embodiment 10. The method according to any one of the preceding embodiments, wherein the method comprises predefining the scanning area, wherein the scanning area is pre-defined by using information retrieved from other cell differentiation modules or analyzers.

Embodiment 11. The method according to any one of the preceding embodiments, wherein the method comprises automatic scanning a plurality of microscopic slides.

Embodiment 12. The method according to any one of the preceding embodiments, wherein the image scanner comprises at least one bright field microscope, at least one phase contrast microscope, or at least one fluorescence microscope.

Embodiment 13. The method according to any one of the preceding embodiments, wherein the method comprises transferring image data to at least one digital storage.

Embodiment 14. The method according to any one of the preceding embodiments, wherein the method comprises classifying and counting cells of a plurality of cell groups of interest, wherein an accumulated cell count per cell group of interest is determined, wherein the image data acquisition of said microscopic slide is discontinued as soon as the determined accumulated cell counts of the cell groups of interest reach the pre-defined minimum cell count of the respective cell group of interest and the repeating method for a next microscopic slide.

Embodiment 15. The method according to the preceding embodiment, wherein the method comprises adapting the scanning area of the microscopic slide by using the controlling device in case the determined accumulated cell counts of the cell groups of interest are below the respective pre-defined minimum cell count of the respective cell group of interest after scanning the pre-defined scanning area, wherein the image scanner prolongs image data acquisition, classifying and counting cells until for each cell group of interest the pre-defined minimum cell count of the respective cell group of interest is reached.

Embodiment 16. The method according to any one of the preceding embodiments, wherein the method comprises performing at least one workflow subsequent to discontinuing of the image data acquisition, wherein the workflow comprises one or more of further processing, storage, wasting, sample aspiration, slide preparation, slide staining.

Embodiment 17. The method according to any one of the preceding embodiments, wherein the method further comprises at least one sample preparation step, wherein the sample preparation step comprises at least one action selected from the group consisting of: dissolving, suspending or dispersing a sample in an appropriate liquid; applying a sample to the microscopic slide; staining the sample.

Embodiment 18. The method according to the preceding embodiment, wherein the sample is applied to the microscopic slide by using at least one printing technique, wherein the applying the sample to the microscopic slide comprises dispensing a known volume of sample by an applicator in two or more rows over an area of the substrate to form a monolayer of the biological entities.

Embodiment 19. The method according to any one of the preceding embodiments, wherein the method is performed completely automatically.

Embodiment 20. The method according to any one of the preceding method embodiments, wherein the method is computer-implemented.

Embodiment 21. A cell analyzer device configured for performing a method according to any one of the preceding embodiments, wherein the cell analyzer comprises
at least one image scanner configured for image data acquisition, wherein the image data acquisition comprises generating microscopic images by scanning at least one pre-defined scanning area of at least one microscopic slide;
at least one processing device configured for determining at least one feature characterizing at least one biological entity of the sample by applying at least one classification algorithm to the microscopic images, wherein the processing device is configured for comparing the feature characterizing at least one biological entity of the sample to at least one pre-defined criterion, wherein the processing device is configured for performing the determining and the comparing in parallel to the image data acquisition performed by the image scanner;
at least one controlling device configured for discontinuing the image data acquisition of said microscopic slide as soon as the determined feature reaches the pre-defined criterion, and to continue with image data acquisition of a next microscopic slide.

Embodiment 22. The cell analyzer device according to the preceding embodiment, wherein the image scanner comprises at least one bright field microscope, at least one phase contrast microscope, or at least one fluorescence microscope.

Embodiment 23. The cell analyzer device according to any one of the preceding embodiments referring to a cell analyzer device, wherein the cell analyzer comprises at least one digital storage to which image data is transferable from the image scanner.

Embodiment 24. The cell analyzer device according to any one of the preceding embodiments referring to a cell analyzer device, wherein the image scanner comprises at least one slide buffer.

Embodiment 25. The cell analyzer device according to any one of the preceding embodiments referring to a cell analyzer device, wherein the image scanner is configured for autonomously scanning the microscopic slide.

Embodiment 26. The cell analyzer device according to the preceding embodiment, wherein the image scanner is configured for moving the microscopic slide in lateral (x-y) direction.

Embodiment 27. The cell analyzer device according to any one of the two preceding embodiments, wherein the image scanner is configured for autonomously adjusting a microscope focus and lightning conditions.

Embodiment 28. The cell analyzer device according to any one of the preceding embodiments referring to a cell analyzer device, wherein the processing device is a control logic of the image scanner and/or a remote device to which the image scanner is connected.

Embodiment 29. A computer program comprising instructions which, when the program is executed by the cell analyzer device according to any one of the preceding embodiments referring to a cell analyzer device, cause the cell analyzer device to perform the method according to any one of the preceding embodiments referring to a method.

Embodiment 30. A computer-readable storage medium comprising instructions which, when the instructions are executed by the cell analyzer device according to any one of the preceding embodiments referring to a cell analyzer device, cause the cell analyzer device to perform the method according to any one of the preceding embodiments referring to a method.

Embodiment 31. A non-transient computer-readable medium including instructions that, when executed by one or more processors, cause the one or more processors to perform the method according to any one of the preceding embodiments referring to a method.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows a float chart of a method according to the present invention;

FIG. 2 shows a dialed distribution of WBCs across 5000 samples. The expected concentration of WBCs/μl of whole blood preparation of a healthy subject plotted vs. the occurences. The data shows that in 0.5 μl or less of the sample volume a sufficient number of 1100 cells can be found. The dialed numbers are used to demonstrate the effectiveness of the method.

FIGS. 3A and 3B show the results of the simulation of the dynamic scanning work flow based on the dialed distribution depicted in FIG. 2. FIG. 3A depicts a histogram of the average scan time per sample to reach a cell count of 1100 WBCs. The scan time expected per sample is plotted vs the occurrence. On average 30 s were needed to reach a count of 1100 WBCs. FIG. 3B shows the actual number of WBCs counted per sample vs the actual scan volume needed; here 0.25 μl.

FIG. 4 depicts a schematic representation of an exemplified image scanner.

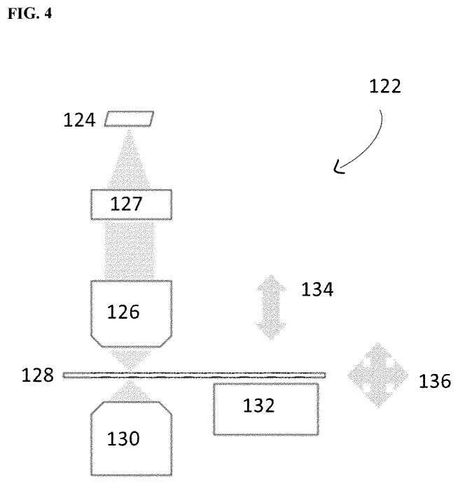

### DETAILED DESCRIPTION OF THE EMBODIMENTS

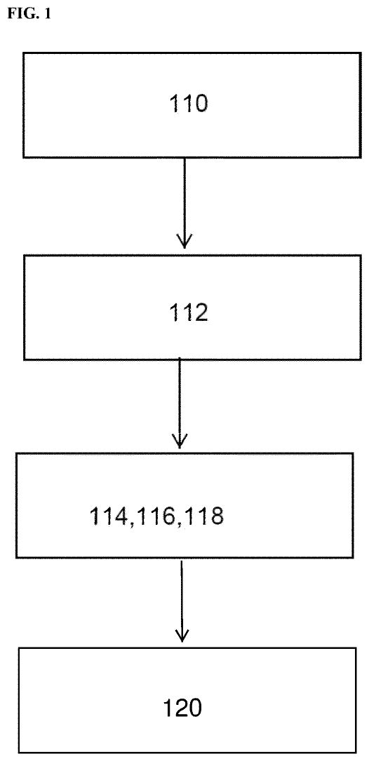

FIG. 1 shows a flow chart of an exemplary embodiment of a method for automated microscopic scanning. The method comprises the following steps:
a. (110) image data acquisition, wherein the image data acquisition comprises generating microscopic images of a sample by scanning at least one pre-defined scanning area of at least one microscopic slide (128) carrying the sample by using at least one image scanner (122);
b. (112) determining at least one feature characterizing at least one biological entity of the sample by applying at least one classification algorithm to the microscopic images by using at least one processing device, wherein the feature is compared to at least one pre-defined criterion, wherein the determining and the comparing is performed in parallel to the image data acquisition, wherein the image data acquisition of said microscopic slide (128) is discontinued by at least one controlling device of the image scanner (122) as soon as the determined feature reaches the pre-defined criterion;
c. repeating the method for a next microscopic slide (128).

The method may be performed completely by means of at least one computer and/or computer network and/or machine, in particular without manual action and/or interaction with a user. The method may be performed completely automatically.

The microscopic slide 128 may be a glass slide. However, further kinds of materials for the slides may also be feasible. The microscopic slide may have a shape which may enable imaging of the sample mounted on the microscopic slide.

The microscopic scanning may comprise imaging the microscopic slide 128 at a plurality of different x,y-position positions, e.g. at a defined magnification. The x,y-position may be set using at least one xy-stage 132, e.g. a motorized xy-stage, to move the microscopic slide. The xy-stage 132 may be connectable with the microscopic slide 128, e.g. by use of a holder, for relative positioning of the microscopic slide and the image sensor. The xy-stage 132 may be a motorized stage. The xy-stage 132 may be configured for controlling axial movement of the microscopic slide transversal to an optical axis, e.g. in the x,y-plane.

The microscopic image may be an image of at least one area of the microscopic slide generated by using at least one image scanner 122, e.g. a scanning microscope. The microscopic scanning may be performed using at least one canning microscope. The microscopic images may be generated as digital images, e.g. as image data. It is also noted that the method described herein may be used in connection with microscope slide scanning instrument architectures and techniques for image capture, stitching and magnification as described in US 2008/0240613 A1 and U.S. Pat. No. 10,061,107 B2 which are incorporated herein by reference, including features in connection with reconstituting an image.

The image scanner 122, for example, may comprise at least one bright field microscope, at least one phase contrast microscope, or at least one fluorescence microscope such as at least one epifluorescence microscope or at least one confocal microscope.

The image scanner 122 may comprise at least one microscope objective 126, 127. The microscope objective may comprise at least one lens, e.g. at least one imaging lens and/or at least one objective lens. The microscope objective 126, 127 may comprise a plurality of lenses such as a lens system. The microscope objective 126, 127 may be configured for receiving at least one incident light beam generated by the sample in response to the illumination. The microscope objective 126, 127 may be configured for generating, e.g. in combination with the imaging lens, an image of the sample on at least one imaging sensor 124. The microscope objective 126, 127, e.g. the at least one objective lens, may have a magnification. The magnification may range from 4× to 100×. For example, the magnification may be 20×. The microscope objective 126, 127 may comprise at least one zoom lens and/or at least one zoom lens system.

The image scanner 122 may comprise further optical elements. For example, the image scanner 122 may comprise at least one fluorescence microscope, wherein the fluorescence microscope may comprise further optical elements such as one or more of at least one excitation filter, at least one dichroic mirror, at least one dichroic beam splitter, and at least one emission filter. For example, the image scanner 122 may comprise at least one bright field microscope, wherein the bright field microscope may comprise further optical elements such as at least one condenser lens configured for focusing light from the illumination device onto the sample.

The image scanner 122 may comprise at least one image sensor 124. As an example, the imaging sensor 124 may comprise at least one camera chip, such as at least one CCD chip and/or at least one CMOS chip. The imaging sensor 124 may comprise at least one camera, wherein the camera is a charge-coupled device (CCD) and/or a complimentary metal-oxide semiconductor (CMOS) image sensor. However, further kinds of imaging devices may also be feasible.

The method, in step a) 110, may comprise illuminating at least partially the microscopic slide 128 by using at least one illumination device 130. The illumination device 130 may be configured for emitting light having a single wavelength or may be configured for simultaneously emitting light having different wavelength. Other options, however, are also feasible. The illumination device 130 may comprise at least one light source. The illumination device 130 may comprise additional elements such as at least one condenser and/or optical elements for setting a direction of propagation of the light beam generated by the light source. The condenser may comprise at least one optical lens configured for transforming a divergent light beam from the light source into a parallel or converging light beam.

For example, the image scanner 122 may comprise at least one bright field microscope. The illumination of the sample may comprise transillumination of the slide. The illumination may be arranged for transmission through the slide or reflection from the slide. The microscopic slide may be arranged between the illumination device and the microscope objective 126, 127. The illumination device 130 of the bright field microscope may be at least one illumination light source, e.g. a halogen lamp, an incandescent light source or a light emitting diode (LED). For example, light in the visible spectral range may be used. For example, light in the spectral range from 400 nm to 800 nm may be used. The sample disposed on the microscopic slide 128 may generate, e.g. emit, in response to the illumination at least one light beam such as by transmission. The light beam emitted in response to the illumination may be at least one signal emitted in response to illumination in the visible spectral range. The sample may be stained to increase color differentiation and contrast. The emitted signal may be color pattern and/or attenuation of the transmitted light. The wavelength range of the illumination light source may span the full range from ultraviolet (<400 nm) to infrared light (>800 nm). Additionally the wavelength range of the illumination light source may span only one or multiple limited wavelength ranges e.g. from monochrome LEDs or as result of placing spectral band pass filters.

For example, the image scanner 122 comprises at least one fluorescence microscope, wherein the illumination device 130 may comprise one or more of at least one xenon arc lamp, at least one mercury-vapor lamp, at least one LED, or at least one laser light source. The illumination device may be configured for illuminating of the sample with illumination light which is absorbed by fluorophores of the sample, causing them to emit light. The emitted light, e.g. the emitted signal, may be of a different wavelength(s) than that of the illumination light. The emitted signal may be a fluorescence signal. The spectral bands of illumination light can be confined to narrow bands of e.g. 10-100 nm, with center wavelengths ranging from <300 to>900 nm.

The scanning area may be a region of the microscopic slide 128 that comprises at least a portion of the sample. The scanning area is pre-defined. For example, the scanning may be pre-defined automatically and/or manually. The method may comprise predefining the scanning area. The scanning area may pre-defined by using information retrieved from other cell differentiation modules or analyzers, e.g. such as from flow cytometers. The scanning area may be divided into a plurality of sub-regions. The image scanner 122 may be configured for illuminating and imaging the sub-regions subsequently, e.g. by moving the microscopic slide in x,y direction, thereby generating microscopic images. The image scanner 122 may be configured for autonomously adjusting a microscope focus and lightning conditions.

The method may comprise transferring image data to at least one digital storage. The imaging scanner may comprise at least one communication interface. The digital storage may comprise at least one database. The digital storage may contain an arbitrary collection of information. The digital storage may be or may comprise at least one database selected from the group consisting of: at least one server, at least one server system comprising a plurality of servers, at least one cloud server or cloud computing infrastructure. The digital storage may comprise at least one storage unit configured to store data.

The method may comprise automatic scanning of the microscopic slide 128. The image scanner 122 may be configured for autonomously scanning the microscopic slide. The image scanner 122 may comprise at least one slide receptacle configured for receiving the microscopic slide. The image scanner 122 may be configured for detecting a presence of a microscopic slide in the receptacle. The image scanner 122, e.g. the controlling device, may be configured for starting a chain of processes when detecting a microscopic slide 128 in the receptacle. The image scanner 122 may comprise means for providing the microscopic slide 128 to an imaging position, e.g. at least one stage, e.g. the XY-moving stage 132, and/or at least one gripping device. The image scanner 122 may be configured for moving the microscopic slide 128 in lateral (x-y) direction, e.g. by using the xy-stage 132.

The method may comprise automatic scanning a plurality of microscopic slides 128. The image scanner may receive the microscopic slides 128 one after the other. Other embodiments are feasible. For example, the image scanner 122 may receive the microscopic slides 128 at the same time, e.g. by using a rack. The image scanner 122 may comprise at least one slide buffer. The slide buffer may be a storage device configured for receiving and storing a plurality of microscopic slides 128, e.g. for subsequent processing. The image scanner 122 may be configured for storing the microscopic slides 128 into the slide buffer. The image scanner 122 may be configured for storing the microscopic slides 128 into the slide buffer before microscopic scanning. The image scanner 122 may be configured for transferring the microscopic slide 128 after image scanning into a slide buffer, e.g. back into the slide buffer or into a further slide buffer, e.g. for further processing. The automatic scanning may comprise one or more of receiving the microscopic slides 128, providing the microscopic slides 128 to the imaging position, storing the microscopic slides 128 in a slide buffer, scanning the microscopic slides 128, applying at least one further workflow to the microscopic slides 128 subsequent to scanning. The complete chain of processes from receiving to scanning or even the further workflow to the microscopic slides 128 subsequent to scanning may be performed automatically, e.g. by using the controlling device of the image scanner 122. The process chain may, however, comprise manual steps, such as for loading the slide, correction of the imaging position and the like.

The image scanner 122 comprises at least one controlling device. The controlling device may be configured for controlling the image scanner 122, such as at least one element or unit of the image scanner 122. For example, the controlling device may be configured for controlling the imaging of the image sensor 124. The controlling device may be connected to the image sensor 124. For example, the controlling device may be configured for controlling providing the microscopic slide 128 to the imaging position. The controlling device may be connected to the gripper device and/or the stage 132. For example, the controlling device may be configured for controlling buffering of the microscopic slides 128 in the slide buffer. For example, the controlling device may be configured for controlling transferring image data to at least one digital storage.

The sample may be a liquid sample suspected to comprise at least one biological entity. For example, the sample may be an arbitrary type of body fluid, a sample from a tissue or an organ, or a sample of wash/rinse fluid or a swab or smear obtained, from an outer or inner body surface. The sample may be a liquid sample obtained from, for example, a body fluid such as blood, plasma, serum, urine, saliva, or lacrimal fluid sample, or a synovial, pleural or cerebrospinal fluid or tissue preparation. The sample may be a preparation of whole blood, or a preparation of a body fluid like synovial, pleural or cerebrospinal fluid or tissue.

The at least one feature characterizing the biological entity may be determined by measuring the presence, absence and/or intensity of a signal emitted by the biological entity. As outlined above, said signal may be selected from the group consisting of: a fluorescence signal and a signal emitted in response to illumination in a visible spectral range.

The classification may comprise categorizing features of the microscopic image into at least two categories, such as a feature relating to the biological entity of interest or another feature. The classification may be a differentiation. The classification algorithm may be at least one algorithm designed for performing the classification. The classification algorithm may use at least one parametric model or at least one non-parametric model. The classification algorithm may take the microscopic images and/or features extracted from the microscopic images as input. For example, the extracted features may be shape and/or color statistics. The classification algorithm may use at least one classification algorithm selected from the group consisting of: at least one convolutional neural network (CNN) technology, deconvolutional neural network (DNN) technology, decision trees, point vector, at least one transformer based model, random forest, K-Nearest-Neighbor, and the like.

After classification, the respective features of the microscopic image classified as to relate to the biological entity of interest may be tracked. The method may comprise successively adding up and/or counting the respective classified features of the microscopic image classified as to relate to the biological entity of interest thereby determining the feature characterizing said biological entity of interest, e.g. an accumulated cell count.

In step b), the feature characterizing at least one biological entity of the sample is com pared to at least one pre-defined criterion. The pre-defined criterion may be a pre-set or pre-defined value of the at least one feature characterizing at least one biological entity. For example, the pre-defined criterion may be a pre-defined or pre-set count of the accumulate count of biological entity.

The determining of the feature and the comparing is performed in parallel to the image data acquisition. The classification algorithm may be rung and the comparison may be performed during image data acquisition. For example, the running the classification algorithm and performing the comparison may start as soon as the first microscopic image or a pre-defined number of microscopic images is generated, e.g. as soon as the image data is available on the digital storage. The processing device may be configured for running the classification algorithm in parallel to image acquisition. By comparing the feature to the pre-defined criterion, e.g. the accumulated cell counts per cell group of interest, the image scanner 122 can be controlled in order to insure consistent count data quality across cell groups and samples. The pre-defined criterion can vary between cell types and can have different purposes. E.g. a minimum number of cells needs to be found to ensure a certain statistical significance of the count result (e.g. >1100 WBCs to achieve a CV better than 3%).

The image data acquisition of said microscopic slide 128 is discontinued by the controlling device of the image scanner 122 as soon as the determined feature reaches the pre-defined criterion. For example, as soon as the determined feature reaches the pre-defined criterion, the controlling device may trigger to terminate the image data acquisition. After comparison to predefined target count values a decision may be made by the controlling device whether to continue or interrupt the scanning. For example, as soon as sufficiently large numbers of cells were identified for all relevant cell groups, the image scanner 122 can discontinue the image acquisition and can proceed to the next sample. The classification results may be available with a certain delay. However, the image scanner 122 and/or processing device may be configured for providing the classification results sufficiently fast such that controlling of the imager scanner 122 is effective and an increase of throughput can be achieved. If the scanning can stop early, subsequent samples can be processed earlier, thereby increasing the throughput.

The method may comprise adapting 114 the scanning area of the microscopic slide 128 by using the controlling device in case the determined feature characterizing at least one biological entity of the sample fails to fulfill the pre-defined criterion after scanning the pre-defined scanning area. The pre-defined scanning area may be a standard scan area, which may be pre-defined by the manufacturer or may be pre-defined by the user before operation of the image scanner 122. The adapting 114 may comprise increasing the scanning area. The image scanner 122 may prolong image data acquisition and determining the feature characterizing at least one biological entity of the sample until the pre-defined criterion is reached. The pre-defined criterion may be used for ensuring a certain statistical significance of the result. In case the feature characterizing at least one biological entity does not exceed the pre-defined criterion within a standard scan area, the standard scan area may be adapted. The controlling device may be configured for adapting, e.g. increasing the scanning area, up to a pre-defined maximum scanning area. The maximum scanning area may be pre-defined in view of time constrains.

The method may comprise adapting 116 the scanning area of the microscopic slide 128 by using the controlling device in case a pre-defined number of abnormalities is determined. The pre-defined number of abnormalities may be low a single digit number, e.g. 1. The classification may exhibit abnormal cell types. If an associated count result does exceed a pre-defined number, an adaption, e.g. increase, of the scanning area can be triggered.

The method may comprise performing at least one workflow 118 subsequent to discontinuing of the image data acquisition. For example, the workflow 118 comprises one or more of further processing, storage, wasting, sample aspiration, slide preparation, slide staining. The further processing can include washing and re-staining of the slide. The workflow 118 may further comprise one or more of sample re-testing, reflex testing e.g. based on the acquired test result and/or triggering a subsequent test on another instrument or module.

The method may comprise at least one fail safe step 120. The method may comprise determining artefacts, e.g. by using the classification algorithm. The fail safe step may be triggered depending on the determined artefacts, e.g. a presence of artefacts and/or an amount of artefacts. Artefacts may potentially occur due to aberrations in the sample or aberrations in the slide. For example, certain types of artefacts may indicate stain precipitations or morphological deviations which are known to originate from defective slide preparation. This can be lysed or otherwise damaged cells, pieces or fragments thereof. It may also relate to damage of the slide itself, including damage of the slide material, particular the surface. For example, in case of determining artefacts, processing of method steps a) and b) may be stopped and/or the image data be rejected and/or the microscopic slide 128 may be rejected for use or further use. At least one failsafe decision may be determined and/or at least one failsafe action may be performed. For example, the failsafe step 120 may comprise issuing and/or displaying an error message. The failsafe step may comprise displaying a warning message. For example, the failsafe step may comprise preventing issuing and/or displaying a measurement result. For example, the failsafe step 120 may comprise a request to remove the microscopic slide 128. The failsafe step 120 may be performed repeatedly, e.g. in parallel to image acquisition.

In the following, an exemplary method is described, wherein the biological entity is at least one cell group of interest and the feature characterizing the biological entity may be an accumulated cell count of the cell group of interest.

Step b) may comprise classifying and counting cells of the cell group of interest by applying at least one cell classification algorithm to the microscopic images by using the processing device. An accumulated cell count per cell group of interest may be determined by the processing device. The classification and counting is performed in parallel to the image data acquisition. The image data acquisition of said microscopic slide 128 may be discontinued by at least one controlling device of the image scanner 122 as soon as the determined accumulated cell count of the cell group of interest reaches a pre-defined minimum cell count of the respective cell group of interest.

The method comprises adapting 114 the scanning area of the microscopic slide 128 by using the controlling device in case the determined accumulated cell counts of the cell groups of interest are below the respective pre-defined minimum cell count of the respective cell group of interest after scanning the pre-defined scanning area. The image scanner 122 may prolong image data acquisition, classifying and counting cells until for each cell group of interest the pre-defined minimum cell count of the respective cell group of interest is reached.

### EXAMPLES

The following examples serve to illustrate the invention. They must not be interpreted as limiting with regard to the scope of protection.

### Example 1: Increase of Throughput by Dynamic Scan Range Adjustment—Assessment of Scan Time and Volume

5000 dialed samples of white blood cells were used as a basis for the assessment of scan time and volume. Typically, the preparation of WBCs may for example occur by cell monolayer preparation using blood printing method. Cell fixation and staining may be performed using Romanowsky type staining. Image aquisition may occur by bright field microscopy. Typically, a medium magnification objective lens, e.g. 20×, may be used.

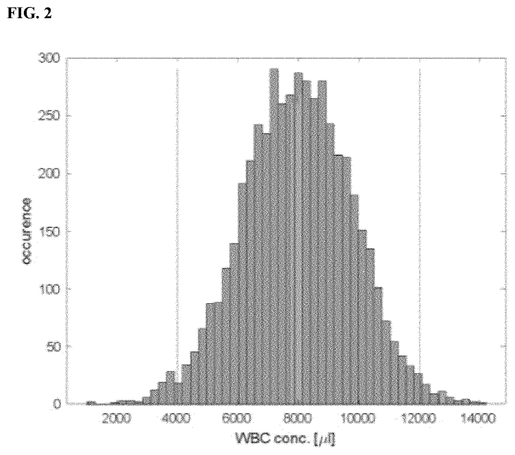

Here, using a Matlab based Monte-Carlo approach, a representative distribution of WBC concentrations was dialed, such that mean and width resemble that of real world blood samples (FIG. 2). Assuming a cobas m511 type scan system (Roche Diagnostics GmbH, Deutschland), monolayer preparation characteristics (i.e. cell area density) and 20× magnification, scan times for lul of printed whole blood are ~100 s.

In a rigid workflow (identical for all samples), the scan area must be set to cover the equivalent of ~0.5 μl of whole blood in order to achieve the min. count of 1100 WBCs. The 1100 limit was chosen to ensure a statistical cell count precision of 3% CV. Given this precision constraint every scan would take about 50 s for each sample and thus limit the throughput, even though there will be many more WBCs detected in most samples.

The analysis conducted suggests that scanning an area corresponding to 0.5 μl of sample volume is sufficient for most WBC preparations to achieve a count of sufficient WBCs.

### Example 2: Increase of Throughput by Dynamic Scan Range Adjustment-Interrupting Scan to Reduce Scan Time

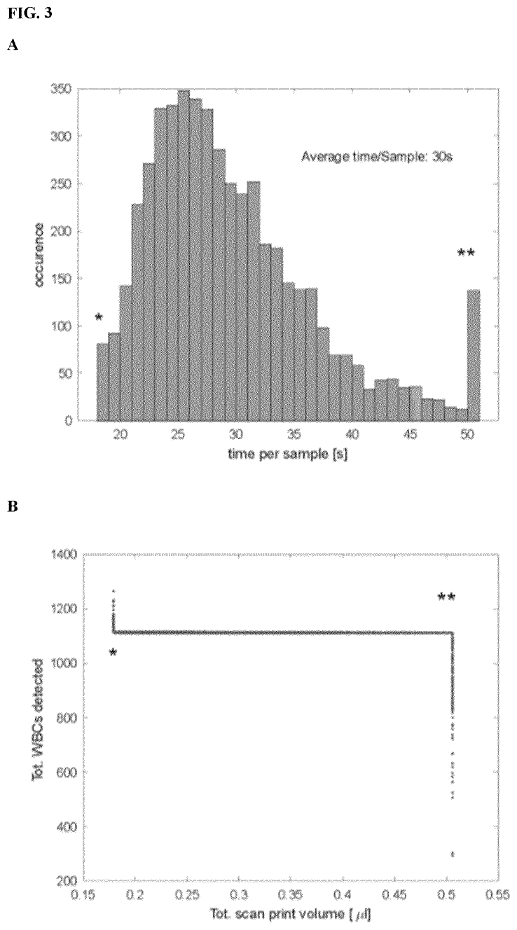

In the simulation of the dynamic scanning work flow, the scan times are accumulated for every dialed WBC concentration, that is needed to achieve the minimum required 1100 cells. The simulation assumed a certain range of allowable scan areas, e.g. a pre-defined scanning area, (equivalent to 0.175 μl to 0.5 μl in this case) in order to ensure overall result quality as well as some physical boundaries of the system (e.g. max. blood smear area). The distribution of effective scan times is shown in FIG. 3A. The average scan time per sample can be calculated from the overall scan time and the total number of dialed samples. The simulation shows that the average scan time can be reduced to ~30 s by the dynamic approach and keeping a consistent statistical data quality across all samples.

FIG. 3B shows the actual number of WBCs counted per sample vs the actual scan volume needed. For the majority, the target of 1100 cells was achieved. Deviations are visible for very low and very high WBC concentrations, either because even the minimum volumes contains more cells, or because the target could not be reached within the max scan volume. The target number of WBCs was set to 1100 in order to reach a sufficient precision (with a coefficient of variation (CV) of 3% or less). The average scan time required to reach the target number of WBCs using a conventional scanning method was 51 s.

Using the automated scanning method in line with the invention the scanning could be interrupted after an average scan time of 30 s. Hence, the automated scanning method according to the invention could be reduce the average scan time from 51 s to 30 s.

### LIST OF REFERENCE NUMBERS

110 image data acquisition
112 determining at least one feature characterizing at least one biological entity
114 adapting
116 adapting
118 workflow
120 fail safe step
122 image scanner
124 imaging sensor
126,127 microscope objective/lens system
128 sample/microscopic slide
130 illumination device
132 xy-stage with slide holder for automated loading and unloading
134 Z-drive
136 XY-drive

1. A method for automated microscopic scanning comprising the following steps:
scanning, by at least one image scanner, at least one pre-defined scanning area of at least one microscopic slide carrying a sample, to generate microscopic images of the sample;
b. comparing, by a processing device and in parallel with generation of the microscopic images by the at least one image scanner, a feature of at least one biological entity of the sample in the microscopic images to at least one pre-defined criterion that includes a pre-set or pre-defined value for the feature, to determine the at least one feature characterizing the at least one biological entity to perform classification, wherein the at least one biological entity is a cell type;
c. discontinuing, by at least one controlling device of the image scanner, generation of the microscopic images of the sample in response to a determination that the feature satisfies the pre-defined criterion; and
d. generating, by the image scanner, additional microscopic images for a next microscopic slide.

2. The method according to claim 1, wherein the feature characterizing at least one biological entity of the sample is a quantitative feature indicative of an abundance of the biological entity in said sample.

3. The method according to claim 1, wherein said feature characterizing the at least one biological entity of the sample is at least one feature selected from the group consisting of an accumulated cell count for a cell type of interest or a cell group of interest, an accumulated count of a virus of interest, and an accumulated count of an extracellular structure of interest.

4. The method of claim 1, wherein the at least one feature characterizing the biological entity is determined by measuring a presence, an absence and/or an intensity of a signal emitted by the biological entity.

5. The method according to claim 1, wherein step b) comprises classifying and counting, by the processing device and in parallel with generation of the microscopic images by the at least one image scanner, cells of at least one cell group of interest determining, by the processing device, an accumulated cell count per cell group of interest and discontinuing generation of the microscopic images comprises discontinuing generation of the microscopic images by the at least one controlling device of the image scanner in response to a determination that the determined accumulated cell count of the cell group of interest satisfies a pre-defined minimum cell count of a respective cell group of interest.

6. The method according to claim 1, wherein the method comprises adapting the scanning area of the microscopic slide by using the controlling device in case the determined feature characterizing at least one biological entity of the sample fails to fulfill the pre-defined criterion after scanning the pre-defined scanning area, wherein the image scanner prolongs generation of the microscopic images and determination of the feature characterizing at least one biological entity of the sample until the pre-defined criterion is satisfied.

7. The method according to claim 1, wherein the processing device utilizes one or more of a convolutional neural network (CNN), a deconvolutional neural network (DNN) a decision tree, a point vector, a random forest, or a K-Nearest-Neighbor operation to classify the at least one biological entity.

8. The method according to claim 1, wherein scanning, by at least one image scanner, the at least one pre-defined scanning area comprises scanning, by an image scanner that comprises at least one bright field microscope or at least one fluorescence microscope, the at least one pre-defined scanning area.

9. The method according to claim 1, wherein the method comprises transferring image data to at least one digital storage.

10. The method according to claim 1, wherein the method comprises classifying and counting cells of a plurality of cell groups of interest, wherein an accumulated cell count per cell group of interest is determined, wherein generation of microscopic images from said microscopic slide is discontinued as soon as the determined accumulated cell counts of the cell groups of interest reach the pre-defined minimum cell count of the respective cell group of interest, wherein the method comprises adapting the scanning area of the microscopic slide by using the controlling device in case the determined accumulated cell counts of the cell groups of interest are below the respective pre-defined minimum cell count of the respective cell group of interest after scanning the pre-defined scanning area, wherein the image scanner prolongs generation of the microscopic images, classifying and counting cells until, for each cell group of interest, the pre-defined minimum cell count of the respective cell group of interest is reached.

11. The method according to claim 1, wherein the sample is applied to the microscopic slide by using at least one printing technique, wherein the applying the sample to the microscopic slide comprises dispensing a known volume of sample by an applicator in two or more rows over an area of the substrate to form a monolayer of the biological entities.

12. A cell analyzer device configured for automated microscopic scanning, wherein the cell analyzer comprises:
at least one image scanner configured to scan at least one pre-defined scanning area of at least one microscopic slide to generate microscopic images of a sample carried by the at least one microscopic slide;
at least one processing device configured to compare, in parallel with generation of the microscopic images by the at least one image scanner, a feature of at least one biological entity of the sample in the microscopic images to at least one pre-defined criterion, to determine the at least one feature characterizing the at least one biological entity to perform classification;
at least one controlling device configured to discontinue generation of the microscopic images in response to a determination that the determined feature satisfies the at least one pre-defined criterion, and to continue with generation of microscopic images from a next microscopic slide.

13. (canceled)

14. A non-transitory computer-readable storage medium comprising instructions which, when the instructions are executed by a cell analyzer device cause the cell analyzer device to:
scan, with an image scanner, at least one pre-defined scanning area of at least one microscopic slide to generate microscopic images of a sample carried by the at least one microscopic slide;
compare, in parallel with generation of the microscopic images by the at least one image scanner, a feature of at least one biological entity of the sample in the microscopic images to at least one pre-defined criterion, to determine the at least one feature characterizing the at least one biological entity to perform classification; and
discontinue generation of the microscopic images in response to a determination that the determined feature satisfies the at least one pre-defined criterion, and continue with generation of additional microscopic images from a next microscopic slide.

15. (canceled)

16. The cell analyzer device of claim 12, wherein to determine the at least one feature characterizing the at least one biological entity comprises to determine a quantitative feature indicative of an abundance of the biological entity in the sample.

17. The cell analyzer device of claim 12, wherein to determine the at least one feature characterizing the at least one biological entity comprises to determine one or more of an accumulated cell count for a cell type of interest or a cell group of interest, an accumulated count of a virus of interest, or an accumulated count of an extracellular structure of interest.

18. The cell analyzer device of claim 12, wherein to determine the at least one feature characterizing the at least one biological entity comprises to measure a presence, an absence or an intensity of a signal emitted by the biological entity.

19. The cell analyzer device of claim 12, wherein the cell analyzer device is configured to:
adapt the scanning area of the microscopic slide in response to a determination that the feature characterizing the at least one biological entity does not satisfy the pre-defined criterion after the pre-defined scanning area has been scanned; and
prolong generation of the microscopic images and determination of the feature characterizing at least one biological entity of the sample until the pre-defined criterion is satisfied.

20. The cell analyzer device of claim 12, wherein the cell analyzer device is configured to utilize one or more of a convolutional neural network (CNN), a deconvolutional neural network (DNN), a decision tree, a point vector, a random forest, or a K-Nearest-Neighbor operation to classify the at least one biological entity.

21. The cell analyzer device of claim 12, wherein the image scanner comprises at least one bright field microscope or at least one fluorescence microscope.

22. The cell analyzer device of claim 12, wherein the cell analyzer device is configured to transfer image data to at least one digital storage.
